(19) United States
(12) Patent Application Publication
(10) Pub. No.: US 2005/0047179 A1
(43) Pub. Date: Mar. 3, 2005

(54) Single-stage power converter with high power factor

(76) Inventor: Ronald A. Lesea, Redwood City, CA (US)

Correspondence Address: LAW OFFICES OF THOMAS E. SCHATZEL;A Professional Corporation, Suite 240, 16400 Lark Avenue, Los Gatos, CA, 95032-2547, US

(21) Appl. No.: 10/650,512

(22) Filed: Aug. 27, 2003

(51) Int. Cl. H02M 1/12

(52) U.S. Cl. 363/47

(57) ABSTRACT

A power supply samples a rectified AC-input waveform and a regulated output voltage and combines them to control an AC-to-DC converter. The operating frequency and/or pulse width modulation of a switched-mode power supply are in large part fixed by a highly filtered output feedback signal to maintain a desired output voltage. A sample taken from the AC-input rectifiers is used in another feedback control signal to drive the operating frequency and/or pulse width modulation slightly up and down as a function of the rise and fall of each rectified-waveform sinusoid. The power delivered to the output, and thus the power demand on the input rise and fall with the instantaneous voltage of the AC input sinusoid. So the power factor is controlled by drawing current in-step with the voltage waveform.

### 1. FIELD OF THE INVENTION

The present invention relates to methods and devices for power conversion, and in particular to single-stage AC to DC power converters that correct power factor and regulate output voltage, output current, or output power in a single stage and with high efficiency.

### 2. DESCRIPTION OF THE PRIOR ART

Where input power factor correction is required, battery chargers, power supplies, and other alternating current (AC) to direct current (DC) power converters commonly correct input power factor in one stage and then do conversion and regulation of the output in a second stage. If each stage is 80% efficient, then the two-stage efficiency is only 80%×80%, or 64%.

FIG. 1 represents a prior-art two-stage power supply 100. An AC input power 102 is brought in through an electromagnetic interference (EMI) filter 104 and converted to DC by an input rectifier 106. A high-frequency capacitor 108 serves as a low impedance for the high frequency current pulses from power factor converter (PFC) 110. A PFC controller 112 sends a control signal 113 that is dependent on an AC-input waveform signal 114. A bulk capacitor 116 smoothes out the power-factor corrected DC and returns a feedback signal 118 to the PFC controller 112. A high-frequency inverter 120 chops the DC from the bulk capacitor 116 in a manner to maintain a constant setpoint output voltage from the power supply 100, for example, for switched-mode power supply operation. An output transformer 122 receives the high frequency chopped output and steps the voltage up or down, depending on the application. An output rectifier(s) 124 converts this back to DC, and output filter(s) 126 removes ripple. An output filter capacitor 128 provides a final stage of filtering to a DC output(s) 130. A feedback signal 132 is used by an inverter controller 134 to generate a control signal 135 for high-frequency inverter 120.

The problem with prior art devices like power supply 100 is there are two stages, each of which is less than 100% efficient.

In general, the power factor in an AC-load will be desirably high, e.g., approaching 1.0, when the waveform of the current being drawn proportionately follows the waveform of the input voltage. The present inventor, Ronald Lesea, has been issued several patents on the subject of power supplies, and power factor correction. For example, see U.S. Pat. No. 5,345,164, issued Sep. 6, 1994, and U.S. Pat. No. 5,635,825, issued Jun. 6, 1997. Both such patents are incorporated herein by reference.

### SUMMARY OF THE INVENTION

It is therefore an object of the present invention to provide a power supply that is efficient.

It is another object of the present invention to provide a power conversion product with good output regulation and high input power factor.

It is another object of the invention to use fewer power components than a two-stage design.

Briefly, a power supply embodiment of the present invention samples the rectified AC input waveform and the output voltage and combines them into a single control in an AC-to-DC converter. The operating frequency and/or pulse width modulation of a switched-mode power supply are generally fixed by a highly filtered output feedback signal to maintain the desired output. A sample taken from the AC-input rectifiers is used in another feedback control signal to run the operating frequency and/or pulse width modulation slightly up and down as a function of the rise and fall of the rectified-waveform sinusoid. Thus the current demand on the input rises and falls with the instantaneous voltage of the AC input sinusoid. So the power factor is controlled by drawing current in-step with the voltage waveform.

An advantage of the present invention is that a power supply and method are provided for high efficiency conversion of AC to DC.

Another advantage of the present invention is that a power supply and method are provided for good regulation and high power factor in the conversion of AC power to DC power.

Another advantage of the present invention is that a power supply and method are provided that uses fewer power components and therefore can be less costly and more reliable.

These and other objects and advantages of the present invention will no doubt become obvious to those of ordinary skill in the art after having read the following detailed description of the preferred embodiments which are illustrated in the various drawing figures.

### IN THE DRAWINGS

FIG. 1 is a functional block diagram of a prior-art two-stage power supply;

FIG. 2 is a functional block diagram of a power supply embodiment of the present invention; and

FIG. 3 is a schematic diagram showing one method for combining both the input power factor control signal and the regulated output feedback signal into one combined signal to control the output switches of a switched-mode power supply like that of FIG. 2.

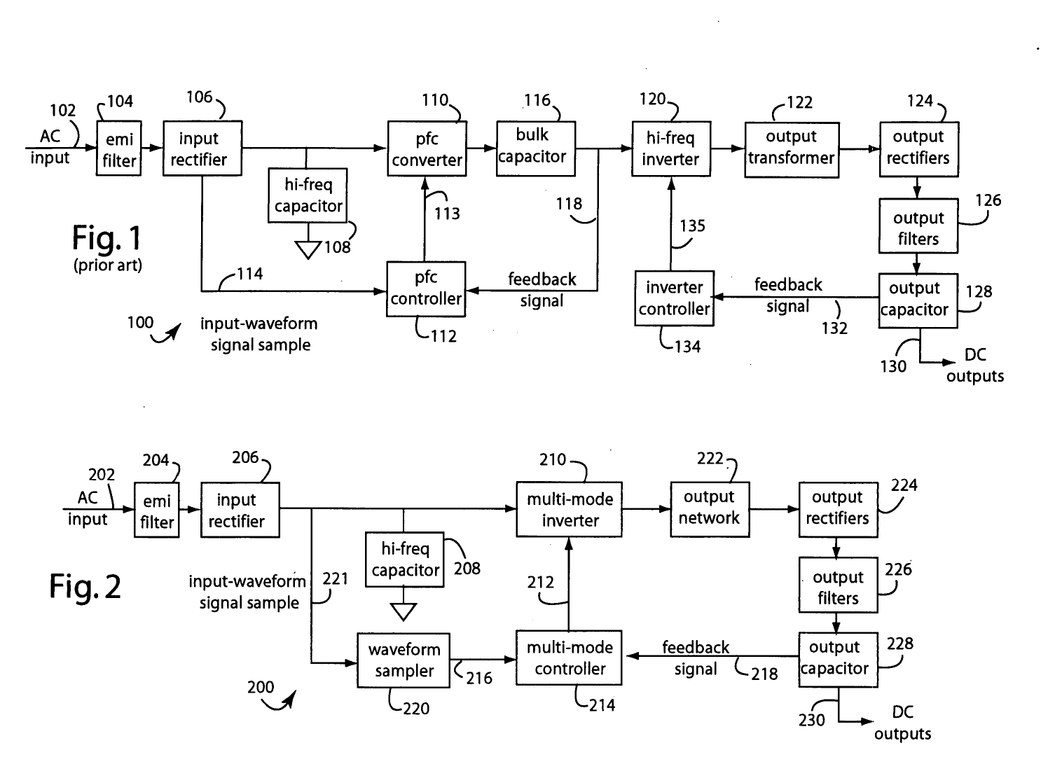

### DETAILED DESCRIPTION OF THE PREFERRED EMBODIMENT

FIG. 2 represents a power supply embodiment of the present invention, and is referred to herein by the general reference numeral 200. An AC input power 202 is brought in through an electro-magnetic interference (EMI) filter 204 and converted to DC by an input rectifier 206. A high-frequency capacitor 208 filters the raw DC for a multi-mode inverter 210. A voltage-controlled frequency generator can be used to implement multi-mode inverter 210. A single controller signal 212 from a multi-mode controller 214 simultaneously provides for output-voltage regulation and input power-factor correction. This single controller signal 212 is synthesized from both an input sample 216 and an output feedback signal 218. A waveform function 220 operates as a sampler and conditions a signal 221 received from the input rectifier 206. The inverter 210 drives an output network 222, e.g., in a switched-mode type of configuration involving switches to chop the incoming DC, step those through a transformer, and then recover the DC power again. An output rectifier(s) 224 converts this back to DC, and an output filter(s) 226 removes ripple. An output filter capacitor 228 provides a final stage of filtering to a DC output(s) 230.

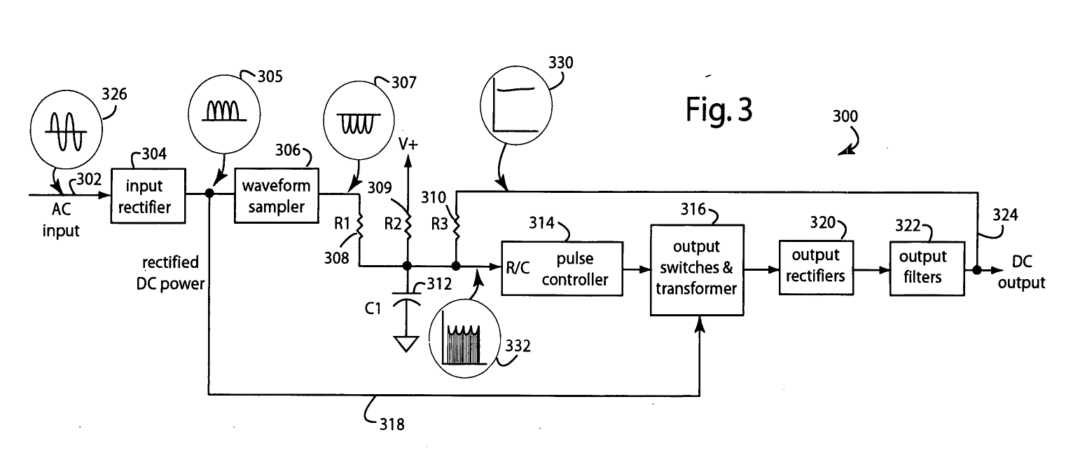

FIG. 3 is a switched-mode power supply like that of FIG. 2, and is referred to herein by the general reference numeral 300. Such FIG. 3 represents one method of implementation for combining both the input power factor control signal and the regulated output feedback signal into one combined signal to control the switched-mode power supply output switches.

Power supply 300 receives an AC-input power 302 that is full-wave rectified by an input rectifier 304 to produce a pulsating DC, as illustrated by waveform 305. The output from input rectifier 304 is shaped by an inverting waveform sampler 306 with an output waveform 307. Such output is fed through a first-weighting resistor (R1) 308 to a summing junction. A second-weighting resistor (R2) 309 and a third-weighting resistor (R3) 310 are connected together at the summing junction with R1 308 to inject a combined charging current into a capacitor (C1) 312.

A pulse controller 314 produces a frequency-modulated and/or pulse-width-modulated output that depends on the respective values of the three weighting resistors R1-R3, the voltages they connect to, and the value of C1 312. A set of output switches and transformer 316 receive a rectified DC power 318 from input rectifier 304 and chop it up according to an input received from the pulse controller 314. A set of output rectifiers 320 provide a high frequency chopped output that is smoothed by a set of output filters 322. A regulated DC-output 324 is the result.

The basic operating point of the frequency-modulated and/or pulse-width-modulated output of pulse controller 314 is set by the combination of resistor (R2) 309, and capacitor (C1) 312. The power delivered to the DC-output 324 is dependent on the frequency and/or pulse-width signals output by the pulse controller 314. The voltage source (V+) at the top of resistor (R2) 309 is constant. The voltages presented respectively at the tops of resistor (R1) 308, and resistor (R3) 310, are able to modestly influence the overall R/C-time-constant seen at the input of pulse controller 314.

In general, the response of pulse controller 314 to changes in the instantaneous voltage present from waveform sampler 306 should be quick enough to follow the derived signal. The response of pulse controller 314 to changes in the DC output voltage present on the top of resistor (R3) 310 should be much slower, but quick enough to react to expected changes in the DC-output load.

The combined, single signal provided to the R/C input of pulse controller 314 therefore controls both AC-input power factor and regulates the DC-output voltage.

Inspecting the signal waveforms around the circuit of power supply 300 is helpful in understanding the operation of this implementation. The AC-input 302 appears as a waveform 326, e.g., a 60-Hz sinewave. The input rectifier 304 converts this into a signal with waveform 305. The DC-output is feedback with a signal that appears as waveform 330.

In one implementation of the present invention, the pulse controller used was a current mode PWM controller, e.g., a Unitrode UC2843A (Texas Instruments, Dallas, Tex.). Such was connected simply to function as a frequency generator that was dependent in its output frequency on the R-C time constants connected to one of its inputs, “RT/CT”. The usual feedback input, “Vfb”, was not used.

The polarity of the signal waveforms 307 and 330 are arranged to make it appear that the DC-output 324 has dropped at each of the peaks of the AC-input waveform 326. So the power level goes up to compensate. The combination of waveforms 307 and 330 appear as in waveform 332. The pulse controller 314 will drive the output switches and transformer 316 a bit less when the rectified DC waveform 307 nears zero, so the power factor is corrected.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the “true” spirit and scope of the invention.

1. A power supply, comprising:
an AC-power input;
a DC-power output;
an inverter for variably delivering more or less power to the DC-power output from the AC-power input that is dependent on a single control signal input;
a sampler connected to sense the instantaneous voltage at the AC-power input;
a feedback loop connected to sense the average of at least one of voltage, current, or power at the DC-power output; and
a multi-mode controller connected to receive weighted signals from the sampler and the feedback loop, and providing for a combination applied to said single-control signal input of the inverter that simultaneously corrects input power factor and regulates the DC-power output.

2. The power supply of claim 1, further comprising:
an input rectifier connected to the AC-power input and for providing a full-wave rectified voltage waveform to the sampler.

3. The power supply of claim 1, wherein:
the inverter has an output frequency dependent on a capacitor and a combination of first through third currents driven into said capacitor through respective first through third weighting resistors, wherein a resulting frequency output drives switches included in the inverter.

4. The power supply of claim 1, wherein:
the inverter has an output frequency dependent on a capacitor and a combination of first through third currents driven into said capacitor through respective first through third weighting resistors, wherein the sampler provides a sample of said instantaneous voltage at the AC-power input to said first weighting resistor, and said feedback loop provides part of said average voltage at the DC-power output to said second weighting resistor;
wherein, a frequency output is dependent on both said instantaneous voltage at the AC-power input and said average voltage at the DC-power output.

5. A power supply, comprising:
a first circuit for input-sampling an AC-power input to a power supply to detect an AC voltage-input waveform;
a second circuit for output-sampling a regulated DC-power output of said power supply;
a third circuit for combining samples taken from said AC voltage-input waveform and said regulated DC-power output into a single control signal; and
a fourth circuit for operating a single power conversion stage with said single control signal to regulate its output according to a weighted combination of the instantaneous AC-voltage present at said AC-power input and an average DC-voltage present of said DC-power output.

6. A method of operating a power supply, the method comprising the steps of:
input-sampling an AC-power input to a power supply to detect an AC voltage-input waveform;
output-sampling a regulated DC-power output of said power supply;
combining samples taken from said AC voltage-input waveform and said regulated DC-power output into a single control signal; and
operating a single power conversion stage with said single control signal to regulate its output according to a weighted combination of the instantaneous AC-voltage present at said AC-power input and an average DC-voltage present of said DC-power output.

7. A power supply, comprising:
an AC-power input;
a DC-power output;
an inverter for delivering a variable amount of power to the DC-power output from the AC-power input and that is dependent on a first and a second control signal input;
a sampler connected to sense an instantaneous voltage at the AC-power input, and for providing said first control signal input;
a feedback loop connected to sense at least one of an average voltage, current, and power at the DC-power output, and for providing said second control signal input; and
a multi-mode controller connected to receive signals from the sampler and the feedback loop, such that one is used primarily to correct an input power factor, and the second control signal is used primarily to regulate the DC-power output.

8. A power supply, comprising:
an AC-power input;
a DC-power output;
an inverter for variably delivering more or less power to the DC-power output from the AC-power input that is dependent on two control signal inputs;
a sampler connected to sense the instantaneous voltage at the AC-power input;
a feedback loop connected to sense the average voltage, current, or power at the DC-power output; and
a multi-mode controller connected to receive the two signals from the sampler and the feedback loop, such that one control signal primarily corrects input power factor by instantaneously varying the frequency of the inverter and the second control signal primarily regulates the DC-power output by controlling the average frequency of the inverter.

9. The power supply of claim 8, wherein the multi-mode controller controls said power factor by instantaneously varying a pulse width and regulates the DC-power output by controlling an average pulse width.

10. The power supply of claim 8, wherein the multi-mode controller controls said power factor by instantaneously varying a pulse width and regulates the DC-power output by controlling an average frequency.

11. The power supply of claim 8, wherein the multi-mode controller controls said power factor by instantaneously varying a frequency and regulates the DC-power output by controlling an average pulse width.
